(19) United States
(12) Patent Application Publication
(10) Pub. No.: US 2023/0345944 A1
(43) Pub. Date: Nov. 2, 2023

(54) Purified and Enhanced Hydrogen Peroxide Disinfecting Solution for the Rapid Inactivation of COVID-19 and Other Pathogens

(71) Applicant: Alira Health Boston LLC, Framingham, MA (US)

(72) Inventors: Mitchell C. Sanders, Southborough, MA (US); Lindsay Poland, Paxton, MA (US); Basnet Prabhat, Worcester, MA (US)

(21) Appl. No.: 18/218,502

(22) Filed: Jul. 5, 2023

Related U.S. Application Data
(63) Continuation of application No. PCT/US2022/011341, filed on Jan. 5, 2022.
(60) Provisional application No. 63/133,997, filed on Jan. 5, 2021.

(51) Int. Cl. A01N 59/00; A01P 1/00; A01N 25/04

(52) U.S. Cl. CPC A01N 59/00; A01P 1/00; A01N 25/04

(57) ABSTRACT

The development, formulations, and uses of a purified and enhanced hydrogen peroxide-based surface disinfectant. The disinfectant is optimized to provide for the rapid inactivation and killing of microorganisms including but not limited to Clostridium difficile, Methicillin Resistant Staphylococcus aureus (MRSA), Pseudomonas aeruginosa, Candida auris, and several viruses such as COVID-19. The hard surface disinfectant is optimized to impart a formulation that has rapid disinfection of microbial pathogens (less than or equal to 45 seconds) and once incorporated into a liquid or moistened wipe provides a cleaning and disinfecting solution which is nonslip and noncorrosive, while leaving minimal residue on the surface.

### CROSS-REFERENCE TO RELATED APPLICATION

This application is a continuation of PCT/US2022/011341 filed Jan. 5, 2022 which claims priority of Provisional Application 63/133,997 filed on Jan. 5, 2021, the entire disclosure of which is incorporated herein by reference for all purposes.

### BACKGROUND

This disclosure relates to hydrogen-peroxide-based disinfectants.

Hydrogen peroxide is often utilized as a hard surface disinfecting solution because it is broad spectrum and at low concentrations of 0.5-8% is safe enough even for use on skin. One of the disadvantages of hydrogen peroxide is that it often contains organic and heavy metal impurities that affect the stability of the disinfecting solution. To overcome these organic and heavy metal impurities prior inventions have utilized an array of metal chelators and other components to improve the shelf life activity of the hydrogen peroxide disinfecting solution. The problem with this approach is that the current hydrogen peroxide disinfecting solutions contain upwards of twenty different chemicals to stabilize, enhance, and prevent corrosion. With all these different ingredients added to the disinfecting solution, the product can leave a lot of residue behind on a surface.

Another disadvantage of hydrogen peroxide is that on its own it has a very modest bactericidal effect referred to as the minimal inhibitory concentration (MIC) of about 1 mM, as such, it requires detergent/surfactant enhancers to accelerate the activity of the disinfecting solution. The problem with most surfactants is that they are quite slippery, and thus pose a potential hazard risk when cleaning floors. An ideal detergent would enhance the antimicrobial activity of hydrogen peroxide but also be less slippery when diluted with water.

Another inherent problem with hydrogen peroxide is that it has a short residence time on a surface, as such on its own it takes several minutes to kill common bacterial and viral pathogens.

### PRIOR ART

### Liquid Hydrogen Peroxide Disinfecting Solutions

U.S. Pat. No. 6,346,279 discloses the properties of hydrogen peroxide with phosphoric and/or a phosphonate, an anionic surfactant, an alkali metal and ammonium salts. The phosphorous based acids were determined to stabilize hydrogen peroxide. Later US patents from Ramirez and colleagues (U.S. Pat. Nos. 6,803,057, 7,632,523, 8,637,085, and 8,999,400) expanded the prior art to include corrosion inhibitors (a benzotriazole, a hydrobenzotriazole, a carboxybenzotriazole, sodium nitrite, sodium molybdate, sodium gluconate and sodium benzoate), an emulsifier (polyoxyethylene surfactant), and additional organic or inorganic acids (phosphoric acid, citric acid, sulfuric acid, sodium hydroxide and or potassium hydroxide) to buffer and stabilize the solution.

U.S. Pat. No. 8,865,196 discloses an environmentally- and user-friendly use of glycolic acid and a thickening agent in a hydrogen peroxide solution to improve the bactericidal activity against Clostridium difficile spores.

### Concentrate or Dried Powder Hydrogen Peroxide Formulations

U.S. Pat. No. 6,686,324 discloses a dry particulate and low foaming concentrate of hydrogen peroxide that has an alkaline pH of 9-11.5. The patent expands the use of corrosion inhibitors and cation sequestering agents such as EDTA to improve the stability of hydrogen peroxide.

U.S. Pat. No. 7,354,604 discloses the use of cyclic carboxylic acids (2-furan carboxylic acid, benzoic acid and salicylic acid) with enhanced antimicrobial activity against mycobacterium species as well as bacterial endospores. This invention also utilized propylene glycol to inhibit corrosion.

U.S. Pat. No. 8,591,958 discloses the use of a concentrated liquid of hydrogen peroxide solution that contains one Pluronic block copolymer surfactant (PLURONIC L62) and a sparingly soluble cyclic carboxylic acid (e.g. salicylic acid) to enhance the activity of the hydrogen peroxide and certain anionic surfactants.

U.S. Pat. No. 8,808,755 discloses a concentrated liquid or dry powder formulation of hydrogen peroxide with a imidazole based detergent (alkyl betaines, alkyl amidopropyl betaines, alkyl amidopropyl betaine amides, alkyl sulfobetaines, amine oxides, and derivatives thereof) and a thickening/skin conditioning agent consisting of polyacrylic acid polymers, polysaccharides, and/or cellulose-based polymers.

U.S. Pat. No. 9,233,180 and 8,304,378 are all-inclusive formulation patents which disclose the use of surfactants, corrosion inhibitors, hydrotropes, cation sequestering agents, hydrogen peroxide stabilizers, solvents, thickeners, skin conditioning agents, antifoams, and pH buffers. The former preferred formulation includes: hydrogen peroxide, phosphoric acid, 1-hydroxy ethylidene 1,1-diphosphonic acid (Briquest ADPA 60 AW), two anionic surfactants/hydrotropes (C6 Dowfax and BioSoft-100), a Polyethylene glycol monooleyl ether (Ethal OA23), and salicylic acid. The latter preferred formulation includes: hydrogen peroxide, phosphoric acid, nonaoic or neo nonaoic acid, propylene glycol propyl ether or ethylene glycol butyl ether, benzyltriazol or tolytriazol, ethoxylate (Alfonic L 610), polyoxyethylene phenyl phosphate ester (Lubrphos LP700), a nonionic surfactant (Lutensol ON 30), benzenesulfonic acid (Marlon AS3), hydroxyethylene 1,1 diphosphonic acid, and chelating agents (Cublen K60/Dequest 2010).

### Recent Minor Improvements

U.S. Pat. Publication No. 20180141814 discloses the use of ethylene carbonate, butylene carbonate and glycerol carbonate to stabilize peroxide. U.S. Pat. Publication No. 20180235231 discloses the utilization of at least one inorganic salt (sulfate, chloride, bromide, iodide, carbonate, phosphate, fluoride, and nitrate) in the hydrogen peroxide formulation.

U.S. Pat. Publication No. 20180279610 relates to using at least one monoalkyl glycerol ether in the hydrogen peroxide formulation.

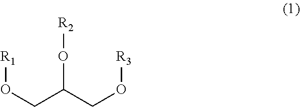

U.S. Pat. Publication No. 20190297881 discloses the use of a sarcosine-based surfactant having the formula (A):

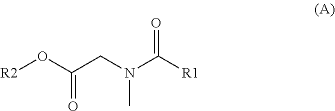

U.S. Pat. Publication No. 20190322964 discloses the use of a biodegradable anionic surfactant.

U.S. Pat. No. 7,658,953 utilizes a formulation that includes a biodegradable surfactant (Multitrope™ 1214) which is a phosphate ester of a natural fatty acid.

U.S. Pat. No. 8,211,849 B2 discloses a formulation with e.g. AKYPO LF4.

### SUMMARY

Aspects include a novel approach to purify the hydrogen peroxide with a combination of activated carbon and/or heavy metal chelating resins in order to develop a solution which is more stable and active without requiring many unnecessary chemicals, to provide a disinfectant that leaves behind a minimal residue.

An approach is to utilize detergents that have a high critical micelle concentration (CMC) which makes them a detergent in concentrated form (above the CMC), but once diluted with water become disperse. This class of anionic, cationic and zwitterionic detergents tend to be less slippery while leaving minimal residue on the surface.

We have utilized the novel approach of mixing hydrogen peroxide with a natural carrier that can make it more persistent and thereby improve killing effectiveness. Such novel carriers include but are not limited to hyaluronan, glycerol triacetate, glycerol monolaurate, tripropylene glycol monomethyl ether, and alginate which can stabilize hydrogen peroxide and improve its residence time to achieve more microbicidal activity. Formulations 087, 253, 256, 258, and 259 (identified elsewhere herein) seem well suited to rapidly deactivate COVID-19 and other viruses.

All examples and features mentioned below can be combined in any technically possible way.

In one aspect, a disinfectant formulation includes purified hydrogen peroxide, ethanol, water, an acid buffer, detergent, stabilizer, quaternary ammonium compound (QAC), and a corrosion inhibitor.

Some examples include one of the above and/or below features, or any combination thereof. In an example the water has a resistance of <18.5 m Ohms. In an example the hydrogen peroxide is pretreated with a divalent binding resin to remove divalent cation impurities. In an example the ethanol has a concentration of 5-10%. In an example the acid buffer comprises one or all of 2 furoic acid, acetic acid, or malic acid.

Some examples include one of the above and/or below features, or any combination thereof. In an example the detergent comprises cocoamidopropyl betaine, TDA 12, or MACAT LHS. In an example the stabilizer comprises one or all of tri(propylene glycol) monomethyl ether, glycerol monolaurate, glycerol triacetate, hyaluronic acid or alginate. In an example the corrosion inhibitor comprises benzotriazole. In an example the disinfectant is anti-slip, anticorrosive, has a slow evaporation rate and imparts minimal residue on a hard surface.

Some examples include one of the above and/or below features, or any combination thereof. In an example the hydrogen peroxide is purified with a combination of activated carbon and a chelating resin. In an example the chelating agent resin comprises Chelex 100, Chelex 20, Lewatit® TP 207, ethylenediaminetetraacetic acid (EDTA), nitrilotriacetic acid (NTA), meso-2,3-dimercaptosuccinic acid (DMSA), or any combination thereof. In an example the activated carbon has a mesh range from 6-60 μm. In an example the formulation comprises 0.5-3.0% hydrogen peroxide containing hyaluronan and/or alginate in a buffered solution to stabilize the hydrogen peroxide and provide persistent activity. In an example the buffered solution comprises sodium acetate, 2 furoic acid, and acetic acid mixed buffer solution with a pH range of from 3.7-5.6.

Some examples include one of the above and/or below features, or any combination thereof. In an example the disinfectant further comprises an anti-slip surfactant that is selected from the class of anionic, nonionic and zwitterionic detergents that have a critical micelle concentration (CMC) from 5-30 mM. In an example the anti-slip surfactant comprises at least one of TDA 12, TDA 18, SDS, HECAMEG, MEGA-8, MEGA-9, MEGA-10, CYMAL-2, CYMAL-5, CHAPS, Kolliphor® P 188, n-Heptyl β-D-thioglucopyranoside, n-Nonyl-β-D-Glucopyranoside, n-Octyl-β-D-thioglucopyranoside, cocoamidopropyl betaine, MACAT LHS, or n-Octyl-b-D-glucopyranoside.

Some examples include one of the above and/or below features, or any combination thereof. In an example the disinfectant further comprises an anticorrosive component that comprises at least one of hexyl-phosphatidyl-N-methyl-ethanolamine or sodium molybdate. In an example the disinfectant further comprises taurocholate or cholic acid, added as disinfectant enhancers that destabilize C. difficile spores. In an example the disinfectant further comprises a select class of plant polyphenols such as oleuropein, added as disinfectant enhancers that destabilize viral particles.

Some examples include one of the above and/or below features, or any combination thereof. In some examples the disinfectant is effective against Clostridium difficile, COVID19, Methicillin Resistant Staphylococcus aureus (MRSA), Salmonella enterica, Candid auris, and Pseudomonas aeruginosa. In an example the kill time for COVID 19 is ≤1 minute. In an example the kill time for MRSA is ≤1 minute. In an example the kill time for Clostridium difficile is ≤4 minutes. In an example the kill time for Pseudomonas aeruginosa is ≤1 minute. In an example the kill time for Salmonella enterica is ≤1 minute. In an example the kill time for Candida auris is ≤1 minute.

### DETAILED DESCRIPTION

Examples discussed herein are not limited in application to the details of formulations and use. They are capable of implementation in other examples and of being practiced or of being carried out in various ways. Examples of specific implementations are provided herein for illustrative purposes only and are not intended to be limiting. In particular, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

One of the benefits of the present disclosure is that the hydrogen peroxide is purified so that it is free of organic and heavy metal contaminants. This improves the stability of the disinfecting solution while imparting minimal residue on the surface. Lin et al, (2008) determined that activated lignite can rapidly remove organic material from industrial hydrogen peroxide with limited loss in the percentage of hydrogen peroxide. In protein biochemistry metal binding resins such as nitrilotriacetic acid (NTA) can be used to purify proteins that have metal binding domains. Alternatively, divalent binding resins such as CHELEX 100 or CHELEX 20 can remove metals during a purification process. The present approach contemplates use of a mixture of an activated carbon with a metal chelator resin to rapidly and inexpensively purify hydrogen peroxide. This purified hydrogen peroxide is much more stable and requires less ingredients to make it a stable and rapid disinfecting solution for microorganisms including COVID-19.

The disclosure in some examples further comprises use of alginate, hyaluronan, glycerol triacetate, glycerol monolaurate, or tri(propylene glycol) monomethyl ether to enhance the residence time of hydrogen peroxide. Each of these components can sequester hydrogen peroxide and improve its residence time and killing effectiveness. Hyaluronan and alginate can provide a carrier to extend the effectiveness of hydrogen peroxide without the requirement for benzalkonium salts. Furthermore, hyaluronate and alginate are strongly amphoteric and can bind and remove protein residue and grease from hard surfaces thus not requiring phosphonic acids.

When the alginate and hyaluronan are chemically bound to a wipe material they can clean the surface without leaving any residue behind. In some examples herein non-woven wipes that have free amino groups are conjugated to the carboxyl groups of alginate or hyaluronan with a zero length carbodiimide crosslinker (1-ethyl-3-(3-dimethylaminopropyl) carbodiimide hydrochloride) (EDC).

Another novel aspect of this formulation is the utilization of a specific class of detergents that have a high critical micelle concentration (CMC) that are nonslip surfactants.

Most of the current hydrogen peroxide detergent formulations are quite slippery and cause potential hazards. In examples herein detergents with a high CMC are used. When concentrated, these act like a detergent to rapidly kill microorganisms such as COVID-19, MRSA, and C. difficile spores, but once diluted with water no longer act like a detergent micelle and are readily removed from the surface. Detergents that have a high CMC (>5mM) and are non-slippery include but are not limited to TDA-12, TDA-18, SDS , HECAMEG, MEGA-8, MEGA-9, MEGA-10, CYMAL-2, CYMAL-5, CHAPS, Kolliphor® P 188, n-Heptyl β-D-thioglucopyranoside, n-Nonyl-β-D-Glucopyranoside, n-Octyl-β-D-thioglucopyranoside, or n-Octyl-b-D-Glucopyranoside.

In addition to these novel approaches to enhance, stabilize and improve residence time of hydrogen peroxide we have been testing ingredients that that can rapidly kill viruses such as COVID-19 and C. difficile spores that are very difficult to kill in less than 4 min with hydrogen peroxide disinfecting solutions. One enhancement that seems to be effective against several viruses are plant polyphenols. For example, oleuropein can enhance the activity of a hydrogen peroxide disinfecting solution for the rapid inactivation of viruses such as COVID-19.

It has been suggested that activating spore germination may be a novel approach to killing C. difficile spores. Others have demonstrated that activating germination makes C. difficile more responsive to killing by ultraviolet-C (UV-C) radiation and heat. However, the major pitfall of these studies was that the enhanced killing required a complex defined medium of bile salts and amino acids which is not cost effective for a cleaning solution. In an effort to better understand whether this approach would be commercially feasible for surface disinfectant we tried to examine whether just bile salts (taurocholate or sodium cholate) with a glycine as a co-germinant could work in a hydrogen peroxide formulation. We determined that this approach led to a one log killing of C. difficile spores in 4 minutes, but it was not as effective as adding a secondary surfactant (Tables 3a and 3b). In this embodiment, we demonstrated that secondary low foaming surfactants such as lauryl hydrosultaine (MACAT LHS) or diphenyl oxide-based betaine surfactants such as Calfax 16L-35, or Caltaine C35 can enhance the killing of C. difficile spores from 2 logs to 6 logs (complete killing) in just under 4 minutes.

Most of the current commercial disinfectant formulations have twenty or more ingredients and as such can leave a residue on a glass surface. Present formulations are more effective at killing bacteria, fungi and viruses while having the least amount of ingredients required for its persistent and high sporicidal activity. Formulations leave a minimal residue and can be used for cleaning glass surfaces. By example, many formulations utilize propyl or butyl acetate to stabilize the H₂O₂. In examples herein the carbon and heavy metal impurities are removed from H₂O₂ using chelating resins and activated charcoal to make a simpler formulation with five ingredients that does not require these stabilizers.

Embodiments include: (1) highly purified H₂O₂ and endotoxin free and deionized H₂O, (2) alginate and or hyaluronate to improve the residence time of the H₂O₂, (3) a detergent with a high CMC such as but not limited to TDA12 or cocoamidopropyl betaine that provides for a solution that is less slippery, and (4) secondary low foaming surfactants preferably but not limited to lauryl hydrosultaine that enhance the sporicidal activity of the H₂O₂. These formulations have a slower evaporation time (longer dry time) which may make it a more effective disinfectant. Lastly, these formulations are more effective than commercially available formulations as represented by the prior art and are compatible with quaternary ammonium compounds (QAC) that are used to treat surfaces for several days.

### Table Legends:

Table 1a. Initial Antimicrobial Formulations with Purified H₂O₂.

Initial attempt to develop a highly purified disinfecting formulation. The formulation contains purified H₂O₂, ultrapure water, hyaluronate, alginate, and a high CMC surfactant and various stabilizers.

Table 1b. Initial Antimicrobial Effectiveness.

The initial formulation was moderately effective against S. aureus, P. aeruginosa, S. enterica and C. auris.

Table 2a. Enhanced Antimicrobial Activity.

The concentration of each ingredient was refined to obtain full antimicrobial and sporicidal activity. An optimal formulation consists of a minimal number of ingredients. A formulation contains purified H₂O₂, ultrapure water, hyaluronate, a high CMC surfactant (TDA-12) and various stabilizers.

Table 2b. Enhanced Killing.

Taurocholate is not sufficient for killing C. difficile spores. The high CMC detergent TDA12 enhances the activity of purified H₂O₂ and makes it an effective cleaning agent.

Table 3a. Enhanced Antimicrobial Activity.

The concentration of each ingredient was refined to obtain full antimicrobial and sporicidal activity. A formulation consists of a minimal number of ingredients: purified H202, ultrapure water, hyaluronate, a high CMC surfactant and various stabilizers.

Table 3b. Enhanced Killing.

Although co-germination ingredients of taurocholate or cholate with glycine had some sporicidal activity the best sporicidal activity was found in formulations that contain a lauryl hydrosultaine (MACAT LHS) or diphenyl oxide-based betaine surfactants. The hyaluronate respectively stabilizes the H₂O₂ and gives it more kill resident time. The high CMC detergent TDA12 or cocoamidopropyl betaine enhance the activity of H₂O₂ and makes it an effective cleaning agent. The hyaluronate is very hydrophilic and our initial results suggest that it has a longer dry time/slower evaporation rate than competing formulation which provides better kill effectiveness.

Table 4a. Summary of Log Reduction.

The formulation contains purified H₂O₂, ultrapure water, hyaluronan or alginate, a high CMC surfactant, a secondary surfactant and various stabilizers.

Table 4b. Enhanced Killing.

A formulation that provides 100% killing of C. difficile, S. aureus, P. aeruginosa, S. enterica and C. auris.

Table 5. Wipe Formulations Tested with Different Non-Woven Microfiber Materials.

We tested various nonwoven wipe materials to make certain that they still provided optimal antimicrobial activity. Four different wipe materials composed of nonwoven structures were incubated with an optimal formulation 087 and incubated with S. aureus to determine the kill effectiveness. The wipe materials utilized are four different nonwoven materials that have different degrees of thickness, tensile strength, and water absorption characteristics. Wipe 2 performed the best.

### Table 6.

A range of concentrations of H₂O₂, 2 furoic acid, hyaluronate, MACAT LHS, and TDA 12 were used to determine the range of applicability for 100% kill in <1 minutes and <4 minutes for C. difficile. Surprisingly, we determined that H₂O₂ was not required in this formulation for S. aureus, P. aeruginosa, C. auris, and S. enterococcus. However, H₂O₂ was required up to 2.5% to get complete kill of C. difficile spores. 2 Furoic acid and MACAT LHS seem to be useful to obtain complete kill of C. auris and C. difficile spores, respectively. In this round of testing we also included silane polyquaternary ammonium compounds (QAC) to improve the kill persistence over a 30 day period. Our initial findings indicate that QAC can be used to get persistent kill of microorganism for up to several days. Efficacy for up to one month is expected.

### Table 7.

Table 7 includes several improved formulations which include Benzotriazole, an antifoaming agent (XFO-478), and another quaternary ammonium compound (QAC) (dodecyltrimethylammonium chloride, DTAC). The antifoam agent XF)-478 improves the wettability of the disinfectant solution and prevents bubbles from forming when using a spray bottle to apply the solution. The quaternary ammonium compound DTAC is effective at killing microorganisms and may enhance the activity of hydrogen peroxide. Benzotriazole is added as a corrosion inhibitor because the optimal pH of the furoic acid is pH 3.0.

TABLE 1a
Initial antimicrobial formulations with Purified H₂O₂

| CHEMICAL | 7/29-021 | 7/29-022 | 7/29-023 | 7/29-024 | 7/29-025 |
|---|---|---|---|---|---|
| Hydrogen Peroxide | + | + | + | + | + |
| 2 furoic acid | + | + | + | + | + |
| Citric Acid | | | | | |
| Butane, ethoxy | + | | + | | + |
| Butane, ethoxy | | | | | |
| Isobutyl acetate | + | + | | | |
| Propyl acetate | | + | + | | |
| Cyclohexasiloxane, | + | | + | | + |
| dodecamethyl | | | | | |
| Oleyl (C18) | + | + | + | + | + |
| alcohol ethoxylate | | | | | |
| Cocamidopropyl | | + | | + | |
| betaine | | | | | |
| Water | + | + | + | + | + |

TABLE 1b
Initial Antimicrobial Effectiveness

| Log Reduction | S. aureus | P. aeruginosa | S. enterica | C. auris |
|---|---|---|---|---|
| 21 | 4 | 6 | 6 | 6 |
| 22 | 4 | 6 | 6 | 6 |
| 23 | 4 | 6 | 6 | 6 |
| 24 | 5 | 6 | 6 | 6 |
| 25 | 5 | 6 | 6 | 6 |

TABLE 2a
Improvements to the formulation with components
that stimulate spore germination

| CHEMICAL | 8/19-065 | 8/19-066 | 8/19-067 | 8/19-068 |
|---|---|---|---|---|
| Purified H2O2 | + | | | |
| Purified H2O2 | | + | | |
| Purified H2O2 | | | + | |
| Purified H2O2 | | | | + |
| 2 furoic acid | | | | |
| 2 furoic acid | + | + | + | + |
| Propyl acetate | + | + | + | |
| Propyl acetate | | | | + |
| Hyluronan | + | + | + | + |
| (1 mg/ml) | | | | |
| TDA-12 | + | + | + | |
| (50 mg/ml) | | | | |
| TDA-12 | | | | + |
| (50 mg/ml) | | | | |
| Oleuropin | + | | + | + |
| (10 mg/ml) | | | | |
| Taurocholate | + | + | + | + |
| (10 mg/ml) | | | | |
| Pure Water | + | + | + | + |

TABLE 2b
Moderate antimicrobial effectiveness of the formulation
with components that stimulate spore germination

| Log | | P. | | | C. |
|---|---|---|---|---|---|
| Reduction | S. aureus | aeruginosa | S. enterica | C. auris | difficile |
| 65 | 6 | 6 | 6 | 6 | 1 |
| 66 | 6 | 6 | 6 | 6 | 1 |
| 67 | 6 | 6 | 6 | 6 | 1 |
| 68 | 6 | 6 | 6 | 6 | 2 |

TABLE 3a
Optimized formulation

| | 8/29- | 8/29- | 8/29- | 8/29- | 8/29- | 8/29- | 8/29- | 8/29- |
|---|---|---|---|---|---|---|---|---|
| CHEMICAL | 081 | 082 | 083 | 084 | 085 | 086 | 087 | 088 |
| Purified | + | | + | | + | + | + | + |
| H2O2 | | | | | | | | |
| Purified | | + | | + | | | | |
| H2O2 | | | | | | | | |
| 2 furoic acid | + | + | + | + | + | + | + | + |
| Propyl | + | | + | | | | | |
| acetate | | | | | | | | |
| Propyl | | + | | + | + | + | + | + |
| acetate | | | | | | | | |
| Hyluronan | + | + | + | + | + | + | + | + |
| (1 mg/ml) | | | | | | | | |
| TDA-12 (50 | + | + | + | + | | | | |
| mg/ml) | | | | | | | | |
| TDA-12 (50 | | | | | + | + | + | + |
| mg/ml) | | | | | | | | |
| Calfax 16L- | | | | | + | | | |
| 35 (1 ml) | | | | | | | | |
| Caltaine C35 | | | + | | | + | | |
| (1 ml) | | | | | | | | |
| MACAT | | | | | | | + | |
| LHS (1 ml) | | | | | | | | |
| Amphosol | | | | | | | | + |
| CG-50 | | | | | | | | |
| Oleuropin | + | + | + | + | | | | |
| (10 mg/ml) | | | | | | | | |
| Taurocholate | + | + | | | | | | |
| (Final 1 | | | | | | | | |
| mg/ml) | | | | | | | | |
| Na Cholate | | | + | + | | | | |
| (Final 1 | | | | | | | | |
| mg/ml) | | | | | | | | |
| glycine | + | + | | | | | | |
| (Final 4 | | | | | | | | |
| mg/ml) | | | | | | | | |
| glycine | | | + | + | | | | |
| (Final 8 | | | | | | | | |
| mg/ml) | | | | | | | | |
| Pure Water | + | + | + | + | + | + | + | + |

TABLE 3b
Optimized formulation with enhanced
C. difficile sporicidal activity.

| | | | | | Log |
|---|---|---|---|---|---|
| C. difficile | 1 | 2 | Average | Std. Dev. | Reduction |
| Control | 1.20E+05 | 1.15E+05 | 1.18E+05 | 3.54E+03 | |
| Sporicidal | 3.80E+01 | 5.60E+01 | 4.70E+01 | 1.27E+01 | 4 |
| 81 | TNTC | TNTC | NA | NA | |
| 82 | 1.06E+03 | 1.40E+03 | 1.23E+03 | 2.40E+02 | 2 |
| 83 | 3.36E+03 | 3.04E+03 | 3.20E+03 | 2.26E+02 | 2 |
| 84 | 1.44E+03 | 1.50E+03 | 1.47E+03 | 4.24E+01 | 2 |
| 85 | 1.16E+03 | 8.00E+02 | 9.80E+02 | 2.55E+02 | 2 |
| 86 | 0.00E+00 | 0.00E+00 | 0.00E+00 | 0.00E+00 | 5 |
| 87 | 0.00E+00 | 0.00E+00 | 0.00E+00 | 0.00E+00 | 5 |
| 88 | 0.00E+00 | 0.00E+00 | 0.00E+00 | 0.00E+00 | 5 |

*TNTC = Too Numerous to count

TABLE 4a
Optimized formulation #087

| Log | P. | S. | S. | C. | C. |
|---|---|---|---|---|---|
| Reduction | aeruginosa | aureus | enterica | auris | difficile |
| Neg. | 1.40E+06 | 3.00E+06 | 4.33E+05 | 1.10E+05 | 6.52E+03 |
| Control | | | | | |
| New RTU | 6 | 6 | 5 | 5 | 2 |
| Old RTU | 6 | 6 | 5 | 5 | 2 |
| 87 | 6 | 6 | 5 | 5 | 3.5 |
| Sporicidal | | | | | 3.5 |

TABLE 4b
Optimized formulation #087

| Microbes | Kill Effectiveness |
|---|---|
| P. aeruginosa | 100% |
| S. aureus | 100% |
| S. enterica | 100% |
| C. auris | 100% |
| C. difficile | 100% |

TABLE 5
Wipes Materials

| S. aureus | Log Reduction | Fold Kill |
|---|---|---|
| Control | 3.52E+05 | 0.00% |
| Wipe 1 | 4 | 99.99% |
| Wipe 2 | 5 | 100.00% |
| Wipe 3 | 4 | 99.99% |
| Wipe 4 | 4 | 99.99% |

TABLE 6
Range of Applicability

| Component | % | % | % | % | Notes |
|---|---|---|---|---|---|
| Purified | 0 | 0.1 | 1 | 2.5 | Required for |
| H2O2 | | | | | C. difficile |
| 2 Furoic Acid | 0.8 | 0.9 | 1 | 1.2 | Essential for |
| | | | | | C. auris |
| Hyaluronic | 0.025 | 0.05 | 0.1 | 0.2 | Stabilizes the |
| Acid | | | | | H2O2 and |
| | | | | | improves |
| TDA 12 | 0.4 | 0.4 | 0.8 | 1 | High CMC |
| | | | | | detergent, |
| | | | | | less slippery |
| | | | | | than |
| | | | | | competing |
| | | | | | surfactants |
| MACAT | 6 | 7 | 8 | 10 | Essential for |
| LHS | | | | | C. difficile |
| Quaternary | 0.1 | 0.4 | 0.6 | 0.8 | Required for |
| Ammonium | | | | | kill up to 30 |
| Compounds | | | | | days |

TABLE 7
Enhanced Formulations 253, 256, 258

| % W:V | CHEMICAL | 253 | 256 | 258 | 259 |
|---|---|---|---|---|---|
| 1.50% | Purified H2O2 | + | + | + | + |
| 1.00% | Ethanol | + | + | + | + |
| 1.00% | 2 furoic acid | + | + | + | + |
| 1.00% | Tripropylene glycol | + | + | + | + |
| | monomethyl ether | | | | |
| 1.00% | Cocoamidopropylbetaine | + | + | + | + |
| 0.10% | Benzotriazole | + | | | |
| 0.30% | Benzotriazole | | + | + | + |
| 1.00% | Dodecyltrimethylammonium | + | + | + | + |
| | Chloride | | | | |
| 0.01% | Antifoam (XFO-478) | | | | + |
| 0.05% | Antifoam (XFO-478) | | | + | |
| 84.00% | Pure Water | + | + | + | + |

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A disinfectant formulation comprising: purified hydrogen peroxide, ethanol, water, an acid buffer, detergent, stabilizer, quaternary ammonium compound (QAC), and a corrosion inhibitor.

2. The disinfectant of claim 1 where the water has a resistance of <18.5 m Ohms.

3. The disinfectant of claim 1 where the hydrogen peroxide is pretreated with a divalent binding resin to remove divalent cation impurities.

4. The disinfectant of claim 1, where the ethanol has a concentration of 5-10%.

5. The disinfectant of claim, where the acid buffer comprises one or all of 2 furoic acid, acetic acid, or malic acid.

6. The disinfectant of claim 1, where the detergent comprises cocoamidopropyl betaine, TDA 12, or MACAT LHS.

7. The disinfectant of claim 1, where the stabilizer comprises one or all of tri(propylene glycol) monomethyl ether, glycerol monolaurate, glycerol triacetate, hyaluronic acid or alginate.

8. The disinfectant of claim 1, where the corrosion inhibitor comprises benzotriazole.

9. The disinfectant of claim 1 which is anti-slip, anticorrosive, has a slow evaporation rate and imparts minimal residue on a hard surface.

10. The disinfectant of claim 1, wherein the hydrogen peroxide is purified with a combination of activated carbon and a chelating resin.

11. The disinfectant of claim 10, wherein the chelating agent resin comprises Chelex 100, Chelex 20, Lewatit® TP 207, ethylenediaminetetraacetic acid (EDTA), nitrilotriacetic acid (NTA), meso-2,3-dimercaptosuccinic acid (DMSA), or any combination thereof.

12. The disinfectant of claim 10, wherein the activated carbon has a mesh range from 6-60 μm.

13. The disinfectant of claim 10, wherein the formulation comprises 0.5-3.0% hydrogen peroxide containing hyaluronan and/or alginate in a buffered solution to stabilize the hydrogen peroxide and provide persistent activity.

14. The disinfectant of claim 13, wherein the buffered solution comprises sodium acetate, 2 furoic acid, and acetic acid mixed buffer solution with a pH range of from 3.7-5.6.

15. The disinfectant of claim 1, comprising an anti-slip surfactant that is selected from the class of anionic, nonionic and zwitterionic detergents that have a critical micelle concentration (CMC) from 5-30 mM.

16. The disinfectant claim 15, where the anti-slip surfactant comprises at least one of TDA 12, TDA 18, SDS, HECAMEG, MEGA-8, MEGA-9, MEGA-10, CYMAL-2, CYMAL-5, CHAPS, Kolliphor® P 188, n-Heptyl β-D-thioglucopyranoside, n-Nonyl-β-D-Glucopyranoside, n-Octyl-β-D-thioglucopyranoside, cocoamidopropyl betaine, MACAT LHS, or n-Octyl-b-D-glucopyranoside.

17. The disinfectant of claim 1, further comprising an anticorrosive component that comprises at least one of hexyl-phosphatidyl-N-methyl-ethanolamine or sodium molybdate.

18. The disinfectant of claim 1, further comprising taurocholate or cholic acid, added as disinfectant enhancers that destabilize C. difficile spores.

19. The disinfectant of claim 1, further comprising a select class of plant polyphenols such as oleuropein, added as disinfectant enhancers that destabilize viral particles.

20. The disinfectant of claim 1 wherein the disinfectant is effective against Clostridium difficile, COVID19, Methicillin Resistant Staphylococcus aureus (MRSA), Salmonella enterica, Candid auris, and Pseudomonas aeruginosa.

21. The disinfectant of claim 20 wherein the kill time for COVID 19 is ≤1 minute.

22. The disinfectant of claim 20 wherein the kill time for MRSA is ≤1 minute.

23. The disinfectant of claim 20 wherein the kill time for Clostridium difficile is ≤4 minutes.

24. The disinfectant of claim 20 wherein the kill time for Pseudomonas aeruginosa is ≤1 minute.

25. The disinfectant of claim 20 wherein the kill time for Salmonella enterica is ≤1 minute.

26. The disinfectant of claim 20 where the kill time for Candida auris is ≤1 minute.
